(19) United States
(12) Patent Application Publication
(10) Pub. No.: US 2008/0273003 A1
(43) Pub. Date: Nov. 6, 2008

(54) Liquid crystal display device, manufacturing method thereof and driving method thereof

(76) Inventor: Sang-Jin Jeon, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/079,559

(22) Filed: Mar. 26, 2008

(30) Foreign Application Priority Data
Mar. 26, 2007 (KR) 2007-029096

(51) Int. Cl. G09G 3/36

(52) U.S. Cl. 345/99

(57) ABSTRACT

An LCD device includes first and second gate drivers coupled on a side of an LCD panel displaying an image, a data driver coupled to the LCD panel adjacent to the second gate driver, a timing controller generating a gate start pulse applied to the first gate driver and control signals applied to the data driver, and at least one gate start pulse supply line supplying the gate start pulse to the first gate driver, a manufacturing method thereof and a driving method thereof.

This application claims priority to Korean Patent Application No. 2007-0029096 filed on Mar. 26, 2007, and all the benefits accruing therefrom under 35 U.S.C. §119, the contents of which are herein incorporated by reference in their entirety.

### BACKGROUND OF THE INVENTION

1. Field of the Invention

The embodiments disclosed relate to a liquid crystal display device and a driving method thereof. More particularly, the embodiments disclosed relate to a liquid crystal display device normally displaying an image regardless of position change of a gate driver and a data driver, a manufacturing method thereof and a driving method thereof.

2. Description of the Related Art

FIG. 1 is a plan view illustrating a driving direction of gate and data lines of a conventional liquid crystal display (LCD) device.

Referring to FIG. 1, the conventional LCD device includes an LCD panel 10 having liquid crystal cells arranged in a matrix configuration to display an image, a data driver 16 driving the LCD panel 10 and a gate driver 13.

The data driver 16 applies a data signal that is formed from an image signal by changing gray-scale to each of data lines DL1, . . . DLm, and the gate driver 13 applies a predetermined voltage to gate lines GL1, . . . GLn, so that switching elements that are connected to the gate lines GL1, . . . GLn are sequentially turned on. Thus, the data signal applied to the data line DL1, . . . DLm is charged in a pixel electrode to display an image on the liquid crystal cell in a downward direction.

A side of the data driver 16 is coupled with the LCD panel 10, and another side of the data driver 16 is coupled with a printed circuit board 17 on which a timing controller 18 and a power supply 19 are mounted.

The timing controller 18 supplies a gate control signal to the gate driver 13, and supplies a data control signal and an image signal to the data driver 16. The power supply 19 supplies gate on/off voltages to the gate driver 13, and supplies a common voltage to the LCD panel 10. The gate driver 13 has a signal line for supplying the gate control signal and the gate on/off voltage.

However, a user may request the locations of the gate driver 13 and the data driver 16 on the LCD panel 10 of the LCD device shown in FIG. 1 be changed. For example, when placing the data driver 16 is on a lower portion of the LCD panel 10 of FIG. 1, the data control signal and the image signal that are from the timing controller 18 and the power supply 19 are applied to lower ends of the data lines DL1, . . . DLm, and the gate control signal and the gate on/off voltages are upwardly applied to the data lines DL1, . . . DLm, so that a switching element of the lowermost gate line GLn is turned on first. Thus, the image of the LCD panel 10 is inverted.

### BRIEF SUMMARY OF THE INVENTION

An exemplary embodiment provides an LCD device having a signal line for applying a gate start pulse to an upper gate line to display an image normally regardless of position change of a gate driver and a data driver, a manufacturing method thereof and a driving method thereof.

In an exemplary embodiment, a liquid crystal display (LCD) device comprises an LCD panel displaying an image; a first gate driver coupled to a side of the LCD panel to drive a switching element connected to a first gate line; a second gate driver driving a switching element coupled to a last gate line; a data driver coupled to another side of the LCD panel adjacent to the second gate driver to drive a data line; a timing controller generating a gate start pulse applied to the first gate driver; and a gate start pulse supply line supplying the gate start pulse to the first gate driver.

The LCD device may further comprise a power supply generating gate on/off voltages applied to the first and second gate drivers, and a common voltage applied to the LCD panel.

The gate start pulse supply line may comprise a common voltage supply line of first to fourth signal line groups and a connection line formed on the LCD panel.

The first signal line group may be formed on the LCD panel between the data driver and the second gate driver, and the second signal line group is formed on the LCD panel between the first and second gate drivers.

The third signal line group may be formed on the first gate driver to be connected to the second signal line group, and the fourth signal line group is formed on the second gate driver to connect between the first and second signal line groups.

The first gate driver may comprise a common voltage supply part connected to the common voltage supply line of the third signal line group; and a gate start pulse input part applying the gate start pulse.

The connection line may connect the common voltage input part with the gate start pulse input part.

The connection line may be formed of a same conductive material and on a same plane as one of the first gate line and the data line.

The gate start pulse supply line may be a single line on the LCD panel.

The gate start pulse supply line may be formed of a same conductive material and on a same plane as the data line.

The LCD panel may further comprise a first signal line group formed on the LCD panel to supply signals generated from the timing controller and the power supply to the second gate driver; and a second signal line group formed on the LCD panel between the first and second gate drivers.

The first gate driver may comprise a third signal line group connected to the second signal line group, the second gate driver may comprise a fourth signal line group connecting the first signal line group to the second signal line group, and the common voltage supplied from the power supply may be applied to the LCD panel through the common voltage line of the first to fourth signal line groups.

The LCD device may further comprise at least one gate driver formed between the first and second gate drivers to drive remaining gate lines except the gate lines connected to the first and second gate drivers.

In another exemplary embodiment, a driving method of an LCD device, comprises supplying gate control signals generated from a timing controller to a plurality of gate drivers; supplying a gate on/off voltage generated from a power supply to the gate drivers; supplying a gate start pulse generated from the timing controller to a first gate driver of the gate drivers, the first gate driver driving a first gate line of an LCD panel; and sequentially driving the gate drivers from the first gate driver so that the LCD panel normally displays an image although position of the gate drivers and a data driver are changed.

The gate start pulse may be applied to the first gate driver by supplying the gate start pulse through a common voltage supply line formed on the LCD panel and a common voltage supply line formed on the gate drivers.

After the gate start pulse is supplied to the first gate driver, the driving method may further comprise sequentially driving gate lines connected to the first gate driver, and then sequentially driving gate lines connected to a next gate driver.

The gate start pulse is applied through a gate start pulse supply line independently formed on the LCD panel.

In still another exemplary embodiment, a manufacturing method of an LCD device, comprises preparing an LCD panel having gate lines and data lines crossing each other, the gate lines and the data lines interposing an insulating layer; coupling a first gate driver for driving a switching element connected to a first gate line and a second gate driver for driving a switching element connected to a last gate line on a side of the LCD panel; coupling a data driver for driving the data line to another side of the LCD panel adjacent to the second gate driver; and forming a gate start pulse supply line supplying a gate start pulse generated from a timing controller to the first gate driver.

The LCD panel may be prepared by forming a first signal line group connecting the data driver to the second gate driver; and forming a second signal line group connecting the first and second gate drivers.

Before the first and second gate drivers are coupled with the side of the LCD panel, the manufacturing method may further comprise forming a third signal line group in the first gate driver to be connected to the second signal line group; and forming a fourth signal line group in the second gate driver to be connected between the first and second signal line groups.

The LCD panel may be prepared by forming a common voltage input part coupled with the first gate driver; and forming a gate start pulse input part receiving the gate start pulse from the first gate driver.

The LCD panel may be prepared by forming a connection line connecting the gate start pulse input part to the common voltage input part.

The connection line may be formed on a same plane and may have a same material as one of the gate line and the data line.

The gate start pulse supply line may be formed by forming a single line on the LCD panel.

The gate start pulse supply line may be formed on a same plane and may have a same conductor as the data line.

### BRIEF DESCRIPTION OF THE DRAWINGS

The above and other advantages of the present embodiments will become readily apparent by reference to the following detailed description when considered in conjunction with the accompanying drawings wherein:

FIG. 1 is a plan view illustrating a driving direction of gate and data lines of a conventional liquid crystal display (LCD) device;

FIG. 2 is a plan view illustrating a first exemplary embodiment of an LCD device;

FIGS. 3A, 4A and 5A are enlarged plan views illustrating a contact region of a thin film transistor (TFT) substrate of the LCD device of FIG. 2 with which a first gate driver is coupled;

FIGS. 3B, 4B and 5B are enlarged cross-sectional views illustrating the contact region of the TFT substrate of the LCD device of FIG. 2 with which the first gate driver is coupled;

FIG. 6 is an enlarged plan view illustrating a contact region of the TFT substrate of the LCD device of FIG. 2 with which a data driver is coupled;

FIG. 7 is a plan view illustrating a second exemplary embodiment of an LCD device;

FIG. 8 is an enlarged plan view illustrating a contact region of a TFT substrate of the LCD device of FIG. 7 with which a first gate driver is coupled; and

FIG. 9 is an enlarged plan view illustrating a contact region of the TFT substrate of the LCD device of FIG. 7 with which a data driver is coupled.

### DETAILED DESCRIPTION

The embodiments disclosed are described more fully hereinafter with reference to the accompanying drawings.

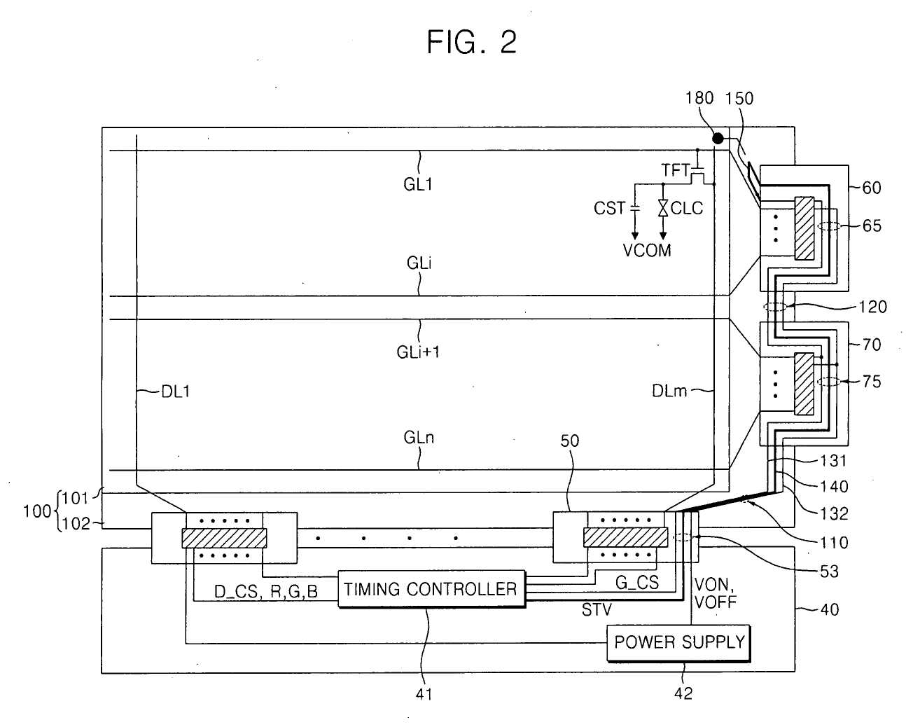

FIG. 2 is a plan view illustrating a first exemplary embodiment of an LCD device.

Referring to FIG. 2, a first exemplary embodiment of an LCD device includes an LCD panel 100 displaying an image, first and second gate drivers 60 and 70 driving gate lines GL1, . . . GLn of the LCD panel 100, a data driver 50 driving data lines DL1, . . . DLm of the LCD panel, a timing controller 41 supplying control signal to the data driver 50 and the first and second gate drivers 60 and 70, a power supply 42 supplying power signals to the first and second gate drivers 60 and 70, the data driver 50 and the LCD panel 100, and a printed circuit board 40 on which the timing controller 41 and the power supply 42 are mounted. A side of the printed circuit board 40 is coupled with the data driver 50.

Particularly, the power supply 42 generates a driving voltage applied to the data driver 50. Also, the power supply 42 generates a gate on voltage VON and a gate off voltage VOFF applied to the first and second gate drivers 60 and 70, and generates a common voltage VCOM applied to the LCD panel 100.

The timing controller 41 generates a data control signal D_CS applied to the data driver 50 and a gate control signal G_CS applied to the gate drivers 60 and 70. Here, the timing controller 41 generates a gate start pulse STV for driving the first gate driver 60. Also, the timing controller 41 supplies red, green and blue image signals R, G, B to the data driver 50. In the embodiment shown in FIG. 2, the power supply 42 and the timing controller 41 are mounted on the printed circuit board 40.

The printed circuit board 40 is coupled with the data driver 50 to supply the control signals and the power signals that are supplied from the timing controller 41 and the power supply 42 to the gate drivers 60 and 70, the data driver 50 and the LCD panel 100.

The gate drivers are coupled with one side of the LCD panel 100. The gate drivers have the first gate driver 60 that is connected to at least one of successive gate lines, having a first gate line GL1 to drive the switching element connected to the successive gate lines, including the first gate line GL1, and the second gate driver 70 that is connected to at least one of successive gate lines having the last gate line GLn to drive the switching element connected to the successive gate lines, including the last gate line GLn. In another exemplary embodiment, the gate drivers further comprises a gate driver that is formed between the first and second gate drivers 60 and 70 and is connected to gate lines disconnected from the successive gate lines connected to the first and second gate drivers 60 and 70.

In the present exemplary embodiment, all the gate lines GL1, . . . GLn of the LCD panel 100 are connected to the first and second gate drivers 60 and 70. In another exemplary embodiment, more than three gate drivers may be connected to the gate lines.

Each of the first and second gate drivers 60 and 70 includes a gate tape carrier package (TCP) on which each of the gate drivers is mounted.

The first gate driver 60 supplies the gate on/off voltages VON/VOFF for turning on/off the switching elements connected to first to i-th gate lines GL1, . . . GLi of the LCD panel 100.

The first gate driver 60 successively drives the gate lines GL1, . . . GLi from the first gate line GL1 toward the i-th gate line GLi. That is, the first gate driver 60 selectively supplies the gate on voltage VON and the gate off voltage VOFF that are supplied from the power supply 42 to the first to i-th gate lines GL1, . . . GLi using the gate control signals G_CS that is supplied from the timing controller 41 and includes the gate start pulse STV, a gate shift clock CPV, an output enable signal OE, a clock signal CKV, a reverse clock signal CKVB, etc.

The second gate driver 70 supplies the gate on/off voltages VON and VOFF for turning on/off the switching elements connected to i+1-th to n-th gate lines GLi+1, . . . GLn of the LCD panel 100. The second gate driver 70 successively drives the gate lines GLi+1, . . . GLn from the i+1-th gate line GLi+1 toward the n-th gate line GLn. That is, the second gate driver 70 selectively supplies the gate on voltage VON and the gate off voltage VOFF that are supplied from the power supply 42 to the i+1-th to n-th gate lines GLi+1, . . . GLn using the gate control signals G_CS that is supplied from the timing controller 41 and includes the gate start pulse STV, a gate shift clock CPV, an output enable signal OE, a clock signal CKV, a reverse clock signal CKVB, etc.

Here, the second gate driver 70 is driven after the first gate driver 60 is driven. That is, the second gate driver 70 is driven after the i-th gate line GLi connected to the first gate driver 60 is turned off.

Each of the first and second gate drivers 60 and 70 has third and fourth signal line groups 65 and 75, respectively.

The third and fourth signal line groups 65 and 75 have a gate control signal supplying line part 131 supplying the gate control signal G_CS, a gate power signal supply line part 132 supplying the gate on voltage VON and the gate off voltage VOFF and a common voltage supply line 140. When the gate start pulse STV is applied to the common voltage supply line 140, the common voltage supply line 140 is used as a gate start pulse supply line.

The data driver 50 has at least one data driver and at least one data TCP on which the data driver is mounted.

The data driver 50 converts the image signal of digital type into a data signal of analog type in response to the data control signal D_CS from the timing controller 41 to supply the converted data signal to the data lines DL1, . . . DLm when the gate on voltage VON is applied to the gate lines GL1, . . . GLn of the LCD panel 100.

A side of the data driver 50 is coupled with the LCD panel 100, and another side of the data driver 50 is coupled with the printed circuit board 40. Here, the data driver 50 for driving the last data line DLm has a fifth signal line group 53 for supplying signals supplied from the timing controller 41 and the power supply 42, which includes the gate control signal G_CS, the gate on voltage VON, the gate off voltage VOFF and the common voltage VCOM.

The LCD panel 100 has a TFT substrate 102 on which a TFT array is formed and a color filter substrate 101 on which a color filter array is formed. The color filter substrate 101 interposes a liquid crystal with the TFT substrate 102.

The color filter substrate 101 has a black matrix, a color filter and a common electrode.

The common electrode applies the common voltage VCOM in response to the data voltage of a pixel electrode formed on the TFT substrate 102. Here, the common electrode receives the common voltage VCOM through short contact points formed between the TFT substrate 102 and the color filter substrate 101.

The TFT substrate 102 has a display part on which the image is displayed and a non-display part formed out of the display part and adjacent to sides of the substrate. The image is not displayed on the non-display part.

The display part has the gate lines GL1, . . . GLn, the data lines DL1, . . . DLm crossing the gate lines GL1, . . . GLn and the thin film transistors TFTs coupled with the gate and data lines GL1, . . . GLn and DL1, . . . DLm.

The gate lines GL1, . . . GLn are formed along a horizontal direction of the TFT substrate 102. The gate lines GL1, . . . GLn have the first gate line GL1 disposed on the uppermost side of the TFT substrate 102, which is firstly driven and the n-th gate line GLn is disposed on the lowermost side of the TFT substrate 102 and is lastly driven.

Pixel regions are defined on the TFT substrate 102 having the gate lines GL1, . . . GLn and the data lines DL1, . . . DLm crossing the gate lines GL1, . . . GLn.

The thin film transistor TFT has a gate electrode coupled with the gate line GL, a source electrode coupled with the data line DL, a drain electrode facing the source electrode and a semiconductor pattern forming a channel between the drain and source electrodes.

The thin film transistor TFT is coupled with the pixel electrode that forms an electric field with the common electrode, and is driven by the gate on voltage VON supplied from the gate line GL to supply the data voltage supplied from the data line DL to the pixel electrode.

The non-display part has first and second signal line groups 110 and 120 and a connection line 150 for supplying the gate start pulse STV.

The first signal line group 110 is formed on the TFT substrate 102 between the data driver 50 and the second gate driver 70. The first signal line group 110 applies gate power signals such as the gate control signal G_CS, the gate on voltage VON and the gate off voltage VOFF to the second gate driver 70. The gate power signals are applied from the data driver 50.

The second signal line group 120 is formed on the TFT substrate 102 between the first gate driver 60 and the second gate driver 70. The second signal line group 120 applies the gate control signal G_CS and the gate on/off voltages VON and VOFF that are applied to the second gate driver 70 to the first gate driver 60.

The first and second signal line groups 110 and 120 include a gate control signal supply line part 131 for supplying the gate shift clock CPV, the output enable signal OE, the clock signal CKV and the inverted clock signal CKVB, a gate driving voltage supply line part 132 for supplying the gate on/off voltages VON and VOFF, and the common voltage supply line 140 for supplying the common voltage VCOM.

The gate control signal supply line part 131, the gate driving voltage supply line part 132 and the common voltage supply lines 140 of the first to fourth signal line groups 110, 120, 65 and 75 are grouped together and first to fourth signal line groups 110, 120, 65 and 75 are connected to each other.

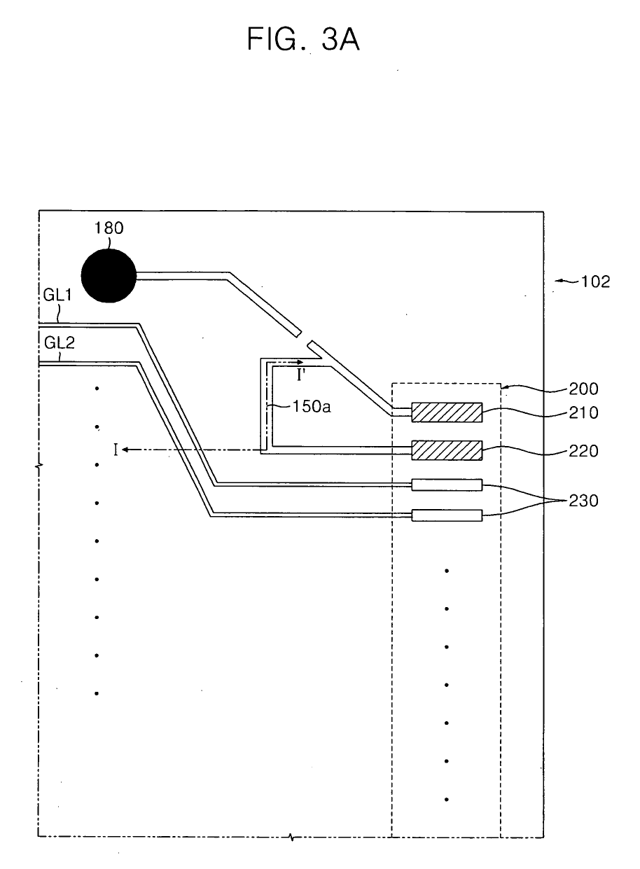

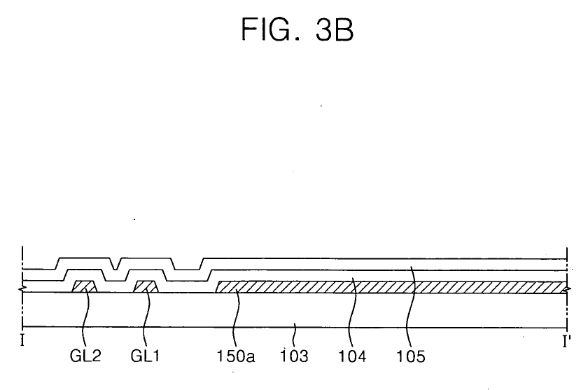

The connection line 150 is formed on the TFT substrate 102, and provides the gate start pulse signal STV that is applied to the common voltage supply line 140 of the first to fourth signal line groups 110, 120, 65 and 75 to the first gate driver 60. The connection line 150 will be explained with reference to FIGS. 3A to 5B.

FIGS. 3A, 4A and 5A are enlarged plan views illustrating a contact region of a thin film transistor (TFT) substrate of the LCD device of FIG. 2 with which a first gate driver is coupled, and FIGS. 3B, 4B and 5B are enlarged cross-sectional views illustrating the contact region of the TFT substrate of the LCD device of FIG. 2 with which the first gate driver is coupled. The first exemplary embodiment of the LCD device will be explained in detail with reference to FIGS. 3A to 5B.

FIG. 3A is a plan view illustrating the region of the non-display region of the TFT substrate with which the first gate driver is coupled. FIG. 3B is a cross-sectional view taken along line I-I′ of FIG. 3A.

Referring to FIGS. 3A and 3B, the display part of the TFT substrate 102 has a gate connection pad part 200 for the connection with the first gate driver 60 of FIG. 2. The gate connection pad part 200 has a common voltage supply pad 210, a gate connection pad 230 and a gate start pulse supply pad 220. Also, the non-display part has a connection line 150a connecting the common voltage supply pad 210 and the gate start pulse supply pad 210.

Particularly, the gate connection pad 230 is connected to each of the gate lines.

The common voltage supply pad 210, as shown in FIG. 3A, is disconnected from the short point 180, and the common voltage supply pad 210 is connected to the connection line 150a. Therefore, the gate start pulse STV is applied through the short point 180 and the disconnected common voltage supply pad 210.

The gate start pulse supply pad 220 is coupled with the first gate driver 60 (shown in FIG. 2) to apply the gate start pulse STV to the first gate driver 60 through the common voltage supply line 140 and the connection line 150a.

The connection line 150a is formed between the common voltage supply pad 210 and the gate start pulse supply pad 220 to electrically connect the common voltage supply pad 210 and the gate start pulse supply pad 220. Here, the connection line 150a comprises a same material and is formed on a same plane as the gate line GL (shown in FIG. 3A).

The connection line 150a formed from the same metal layer as the gate line GL will be explained in detail with reference to FIG. 3B.

Referring to FIG. 3B, in order to form a gate pattern having the gate line GL, the gate electrode and the connection line 150a, a first conductive (e.g., metal) layer is formed. Then, photoresist is formed on the first conductive layer.

Then, the first conductive layer is patterned using a mask for the gate pattern through a photolithography process and an etching process to form the gate pattern having the gate line GL, the gate electrode and the connection line 150a. Then, a gate insulating layer 104 having an insulating material selected from the group consisting of silicon nitride and silicon oxide is formed on the gate pattern. Then, a protecting layer 105 is formed on the gate insulating layer 104.

Here, the connection line 150a may be formed from a same material and on a same plane as the gate line GL.

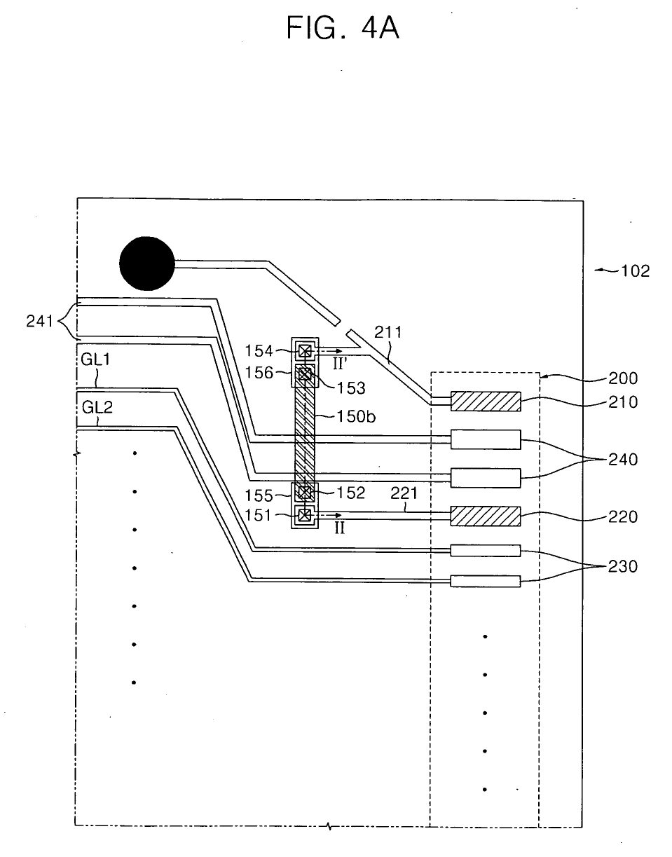

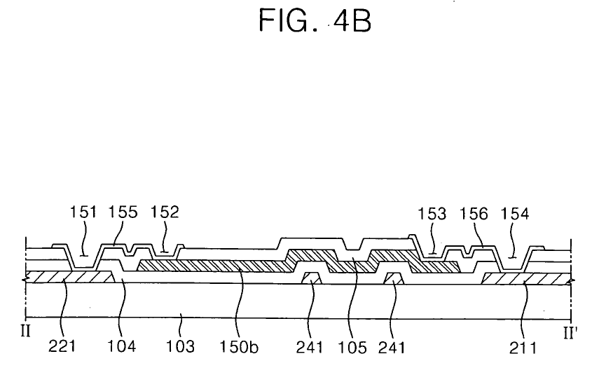

FIG. 4A is a plan view illustrating a connection line formed from a same layer as the data line DL. FIG. 4B is a cross-sectional view taken along line II-II′ shown in FIG. 4A.

Referring to FIGS. 4A and 4B, when a repair line 241 is formed between the common voltage supply pad 210 and the gate start pulse supply pad 220 for repairing disconnection of the gate line GL, a repair pad 240 connected to the repair line 241 is formed. The repair line 241 may be formed from the same first conductive material as the gate line 150b. Therefore, in order to prevent connection between the repair line 241 and the connection line 150b, the connection line 150b may be formed from another conductive (e.g., metal) layer insulated from the repair line 241 by the gate insulating layer 104.

The connection line 150b has a same conductive material (e.g., metal) and may be formed on a same plane as the data line DL. When the connection line 150b has the same metal and is formed on the same plane as the data line DL, a first extension line 221 extended from the gate start pulse supply pad 220 is connected to the connection line 150b through first and second contact holes 151 and 152 and the first contact electrode 155 connecting the exposed portion of the first extension line 221, which is exposed through the first contact hole 151, to the exposed portion of the connection line 150b, which is exposed through the second contact hole 152. The first and second contact holes 151 and 152 are formed through the protecting layer 105 on ends of the first extension line 221 and the connection line 150b. Also, a second connection line 211 extended from the common voltage supply pad 210 is connected to the connection line 150b through third and fourth contact holes 153 and 154 and a second contact electrode 156 connecting the exposed portion of the second connection line 211, which is exposed through the third contact hole 153, to the exposed portion of the connection line 150b, which is exposed through the fourth contact hole 154. The third and fourth contact holes 153 and 154 are formed at ends of the second extension line 211 and the connection line 150b. Here, the first and second contact electrodes 155 and 156 may be formed from a transparent and conductive layer.

A method of forming the connection line 150b from the same metal layer as the data line DL will be explained in detail with reference to FIG. 4B.

Referring to FIG. 4B, the gate pattern having the gate line GL, the gate electrode, the first extension line 221 extended from the gate start pulse supply pad 220 and the second extension line 211 extended from the common voltage supply pad 210 is formed on the insulating substrate 103 as a first conductive layer.

Then, the gate insulating layer 104 having at least one insulating material selected from the group consisting of silicon nitride and silicon oxide is formed on the gate pattern. Then, the data pattern having the source and drain electrodes of the thin film transistor formed in the pixel region, the data line DL and the connection line 150b are formed.

Particularly, the data pattern is formed through photolithography process and etching process after the second conductive layer is formed on the substrate 103 on which the gate insulating layer 104 is formed. Then, the protecting layer 105 having first to fourth contact holes 151 to 154 is formed after the data pattern is formed. Here, the first contact hole 151 is formed through the protecting layer 105 and the gate insulating layer 104 formed under the protecting layer 105 to expose the end of the first extension line 221. The second and third contact holes 152 and 153 are formed through the protecting layer 105 to expose an end and another end of the connection line 150b. The fourth contact hole 154 is formed through the protecting layer 105 and the gate insulating layer 104 formed under the protecting layer 105 to expose the end of the second extension line 211. Then, the first contact electrode 155 is formed connecting the first extension line 221 and the connection line 150b through the first and second contact holes 151 and 152 and the second contact electrode 156 is formed connecting the second extension line 211 and the connection line 150b through the third and fourth contact holes 153 and 154.

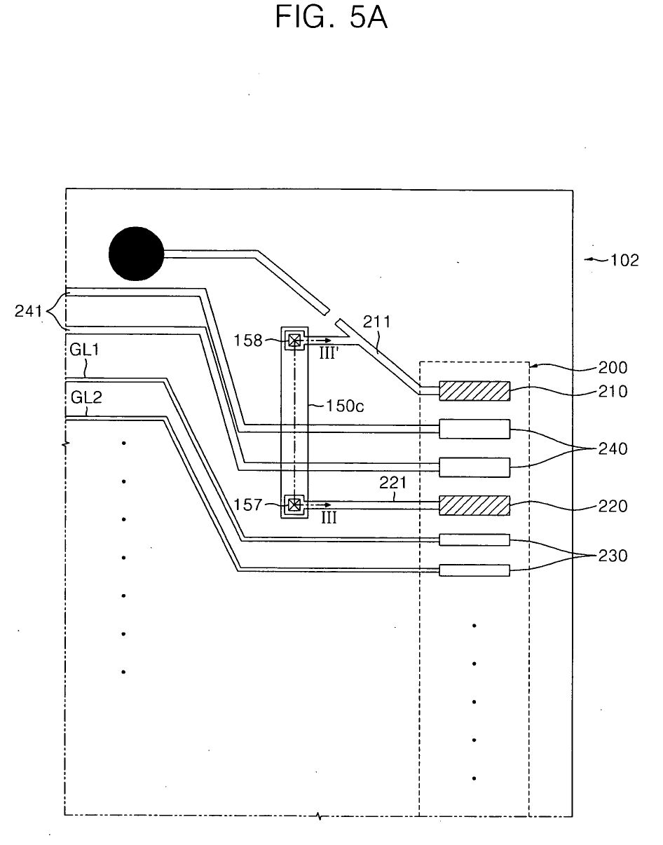

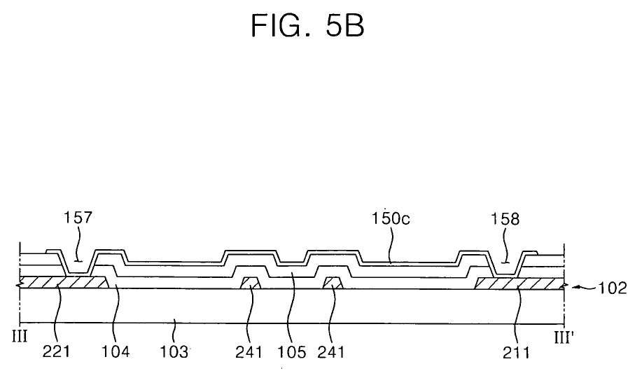

Also, the connection line 150b may be formed from a transparent and conductive layer as shown in FIGS. 5A and 5B.

Referring to FIGS. 5A and 5B, the connection line 150c may be formed from the transparent and conductive layer. That is, the connection line 150c is formed on the protecting layer 105. An end of the connection line 105c is connected to an end of the first connection line 221 through a fifth contact hole 157 that is formed through the protecting layer 105 and the gate insulating layer 104, and another end of the connection line 105c is connected to and end of the second connection line 211 through the protecting layer 105 and the gate insulating layer 104. Therefore, the connection line 150c is insulated from the repair lines 241 by the gate insulating layer 104 and the protecting layer 105.

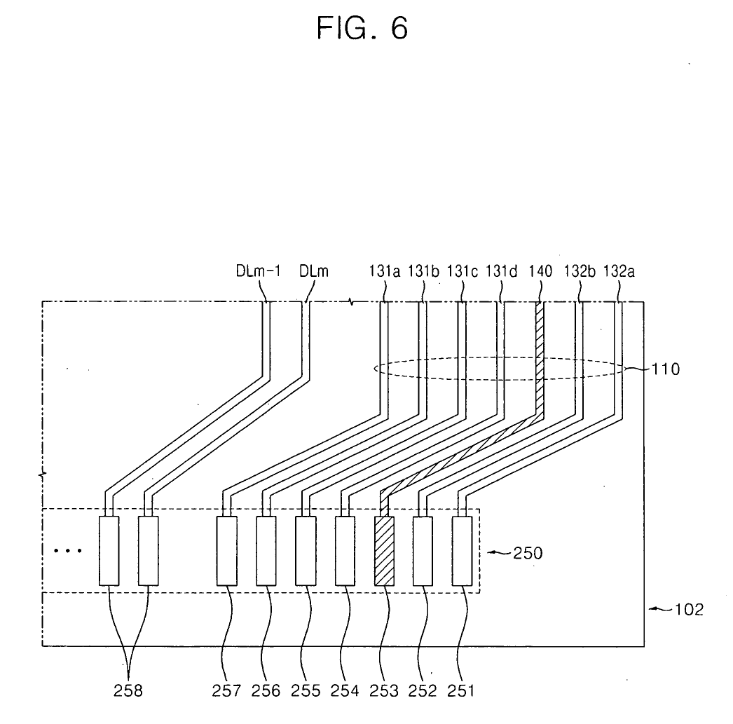

Here, the gate start pulse is applied to a timing controller through the common voltage input pad of the data connection pad part coupled with the data driver 50. The data connection pad part will be explained in detail with reference to FIG. 6.

FIG. 6 is an enlarged plan view illustrating a contact region of the TFT substrate of the LCD device of FIG. 2 with which a data driver is coupled.

Referring to FIG. 6, the data connection pad part 250 has a data connection pad 258 connected to the data line DL, a gate shift clock input pad 254, an output enable signal input pad 255, a clock signal input pad 256, an inverted clock signal input pad 257, a gate on voltage input pad 252, a gate off voltage input pad 251 and a common voltage input pad 253.

Particularly, the data connection pad 258 is connected to the data line DL. That is, the data connection pad 258 is connected to the data driver 50 (shown in FIG. 2) to supply the data voltage applied from the data driver 50 to the data lines DL1, . . . DLm.

The gate shift clock input pad 254, the output enable signal input pad 255, the clock signal input pad 256 and the inverted clock signal input pad 257 are respectively connected to the first to fourth gate control signal supply lines 131a to 131d of the first signal line group 110 to apply the gate shift clock CPV, the output enable signal OE, the clock signal CKV and the inverted clock signal CKVB of the gate control signals G_CS to the first to fourth gate control signal supply lines 131a to 131d of the first signal line group 110.

The gate on voltage input pad 252 and the gate off voltage input pad 251 are connected to the gate on voltage supply line 132b and the gate off voltage supply line 132a of a gate power supply line part of the first signal line group 110. Therefore, the gate on voltage input pad 252 and the gate off voltage input pad 251 respectively apply the gate on voltage VON and the gate off voltage VOFF supplied from the power supply to the gate on voltage supply line 132b and the gate off voltage supply line 132a.

The common voltage input pad 253 is connected to the common voltage supply line 140 of the first signal line group 110. Here, the common voltage input pad 253 may be connected to the data driver to apply the gate start pulse STV supplied from the timing controller to the common voltage supply line 140.

In the present exemplary embodiment of the LCD device, the gate start pulse generated from the timing controller is applied to the first gate driver 60 through the data driver 50, the common voltage input pad 253, the common voltage supply lines of the first to fourth signal line groups 110, 120 65 and 75, respectively, the common voltage supply pad 210, the connection line (e.g., 150a, 150b, or 150c) and the gate start pulse supply pad 220. Therefore, the gate driver 60 is firstly driven to sequentially supply the gate on voltage from the first gate line to the last gate line of the LCD panel. Thus, the image is normally displayed although the position of the data driver is changed.

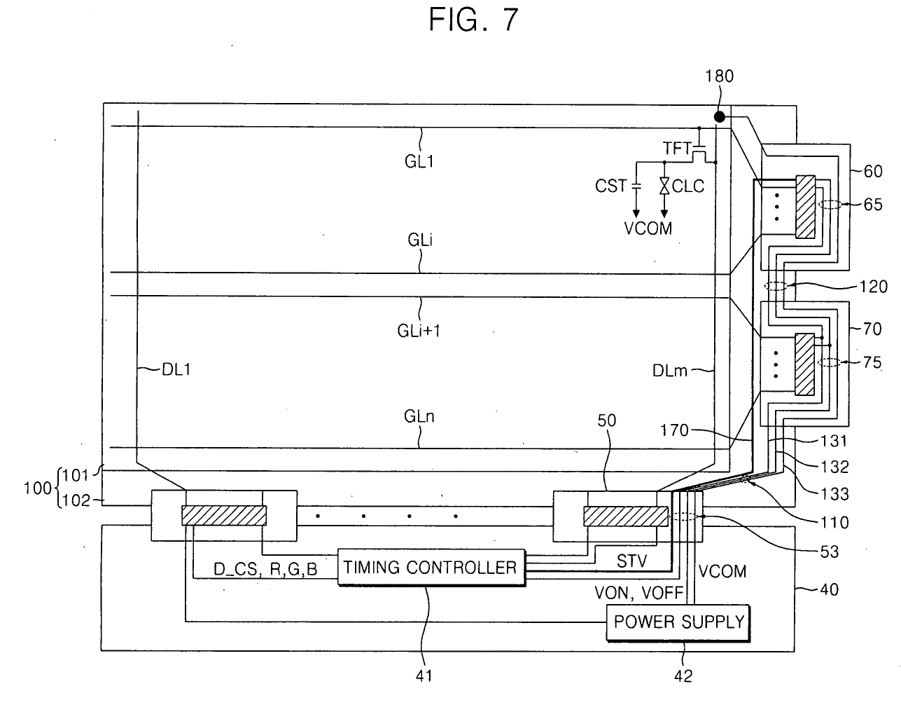

FIG. 7 is a plan view illustrating a second exemplary embodiment of an LCD device.

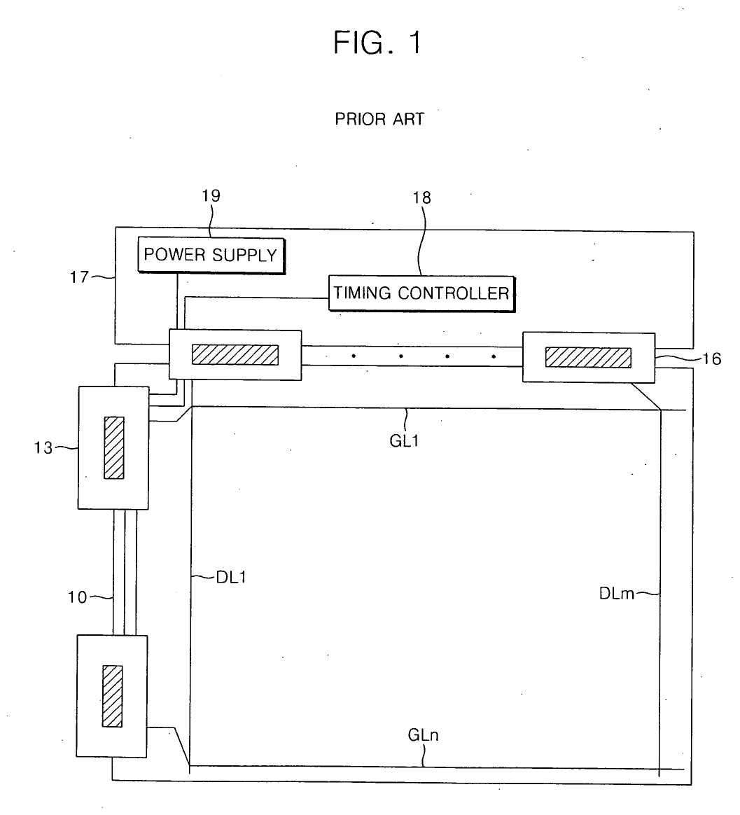

The LCD device of FIG. 7 has same elements as the LCD device of FIG. 1 except the gate start pulse supply line 170. Thus, any further repetitive explanation concerning the above elements will be omitted.

Referring to FIG. 7, a second exemplary embodiment of an LCD device has an LCD panel 100, first and second gate drivers 60 and 70 for driving gate lines GL1, . . . GLn of the LCD panel 100, a data driver 50 for driving data lines DL1, . . . DLm of the LCD panel 100, a timing controller 41 for respectively supplying a gate control signal G_CS and a data control signal D_CS to the first and second gate driver 60 and 70 and the data driver 50, a power supply 42 for supply power to the first and second gate drivers 60 and 70, the data driver 50 and the LCD panel 100, and a gate start pulse supply line 170 formed on the LCD panel 100 to supply a gate start pulse STV generated from the timing controller 41 to the first gate driver 60.

Particularly, the first gate driver 60 is connected to an end of the LCD panel to drive the first to i-th gate lines GL1, . . . GLi. Here, the first gate driver 60 has a third signal line group 65 that has a gate control signal supply line part 131 for supplying a gate shift clock CPV, an output enable signal OE, a clock signal CKV and an inverted clock signal CKVB, a gate driving voltage supply line part 132 for supplying gate on/off voltages VON and VOFF, and a common voltage supply line 133 for supplying a common voltage VCOM.

Here, the third signal line group 65 is electrically connected to a second signal line group 120 formed on the TFT substrate 102.

The second gate driver 70 is coupled to an end of the LCD panel 100 to drive i+1-th to n-th gate lines GLi+1, . . . GLn. Here, the second gate driver 70 has a fourth signal line group 75 that has a gate control signal supply line part 131 for supplying a gate control signal G_CS, a gate driving voltage supply line part 132 for supplying gate on/off voltages VON and VOFF, and a common voltage supply line 133 for supplying a common voltage VCOM. The fourth signal line group 75 is connected to first and second signal line groups 110 and 120 formed on the TFT substrate 102.

The data driver 50 has a data driving part and a data tape carrier package (TCP) on which the data driving part is mounted.

An end of the data driver 50 is connected to the LCD panel 100, and another end of the data driver 50 is connected to a printed circuit board 40. Here, a fifth signal line group 53 for supplying a gate control signal G_CS from a timing controller 41 of the printed circuit board 40 and the gate on/off voltages VON and VOFF from a power supply 42 of the printed circuit board 40 is formed on the data driver 50 adjacent to the second gate driver 70.

The first and second signal line groups 110 and 120 are formed on the TFT substrate 102 of the LCD panel 100, and are electrically connected to the third and fourth signal line groups 65 and 75. Particularly, the first signal line group 110 is formed on the data driver 50 and the second gate driver 70, and the second signal line group 120 is formed between the first gate driver 60 and the second gate driver 70. The first and second signal line groups 110 and 120 has a gate control signal supply line 131, a gate driving voltage supply line 132 for supplying the gate on/off voltages VON and VOFF and a gate common voltage supply line 133.

The gate start pulse supply line 170 is formed on the TFT substrate 102, and is formed on a non-display part adjacent to the first and second gate drivers 60 and 70. The gate start pulse supply line 170 applies the gate start pulse STV supplied from the timing controller 41 to the first gate driver 60. Preferably, the gate start pulse supply line 170 has a same conductive material (e.g., a metal) as the data line DL and is formed on a same plane as the data line DL to be insulated from the gate lines GL1, . . . GLn.

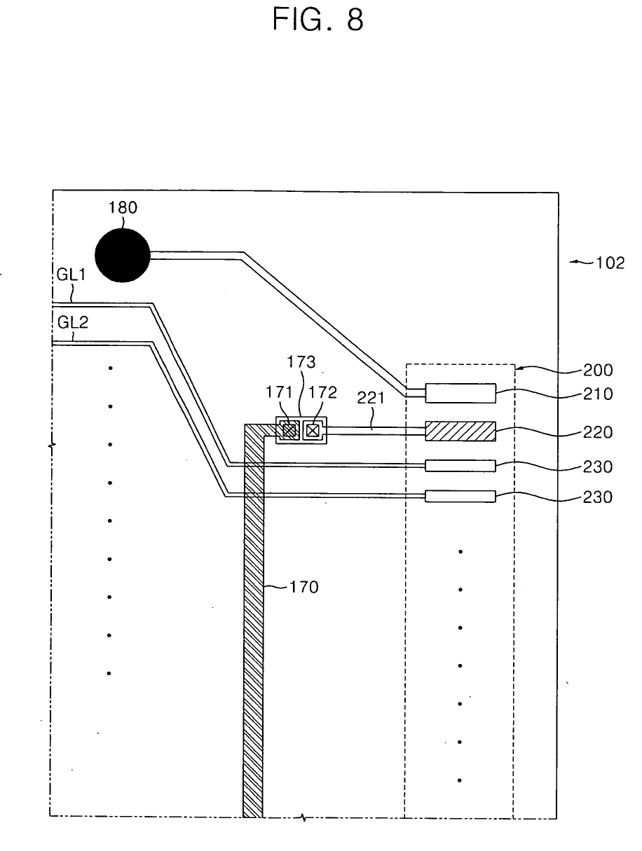

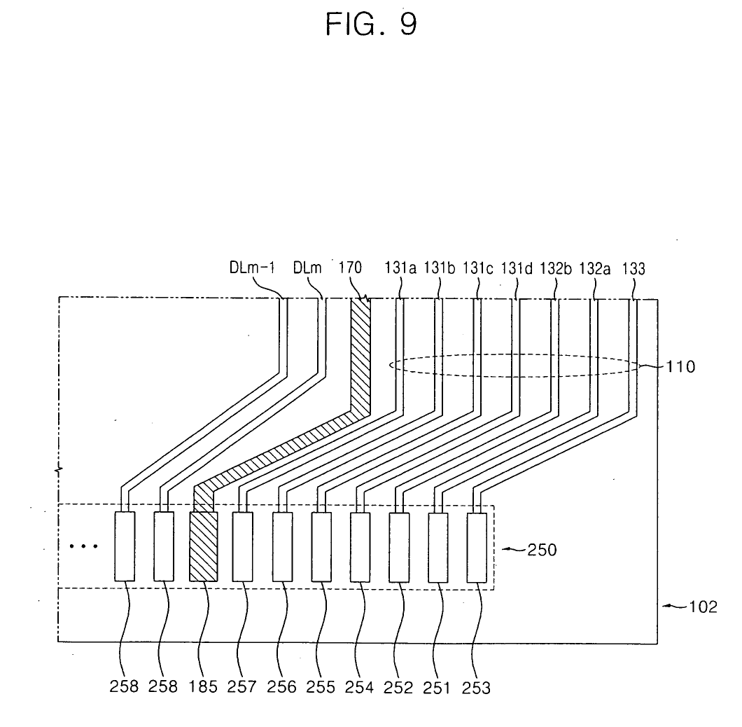

The gate start pulse supply line 170 will be explained in detail with reference to FIGS. 8 and 9.

FIG. 8 is an enlarged plan view illustrating a contact region of a TFT substrate of the LCD device of FIG. 7 with which a first gate driver 60 is coupled. FIG. 9 is an enlarged plan view illustrating a contact region of the TFT substrate of the LCD device of FIG. 7 with which a data driver 50 is coupled.

Referring to FIGS. 8 and 9, the TFT substrate 102 has a gate connection pad part 200 connected to the first gate driver 60 and a data connection pad part 250 connected to the data driver 50.

Particularly, the gate connection pad part 200 has a gate connection pad 230 connected to the gate line GL, a common voltage supply pad 210 connected to the short contact point 180, and a gate start pulse supply pad 220 connected to a gate start pulse supply line 170.

The gate connection pad 230 is connected to the first gate driver 60 to supply the gate on voltage VON and the gate off voltage VOFF to the first to i-th gate lines GL1, . . . GLi. The common voltage supply pad 210 supplies the common voltage VCOM supplied through the common voltage supply line 133 of the third signal line group 65 of the first gate driver 60 to the short contact point 180.

The gate start pulse supply pad 220 is connected to the gate start pulse supply line 170 to supply the gate start pulse STV supplied from the gate start pulse supply line 170 to the first gate driver 60. Here, the gate start pulse supply pad 220 is coupled with the gate start pulse supply line 170 through the contact electrode 173.

When the gate start pulse supply line 170 is formed from a different layer from the gate start pulse supply pad 220, the gate start pulse supply line 170 and the gate start pulse supply pad 220 are connected through the contact electrode 173 after the seventh and eighth contact holes 171 and 172 that are formed to connect the gate start pulse supply line 170 and the gate start pulse supply pad 220. The contact electrode 173 connects the gate start pulse supply line 170 to the gate start pulse supply pad 220 through the seventh contact hole 171 exposing the gate start pulse supply line 170 and the eighth contact hole 172 exposing the first extension line 221 extended from the gate start pulse supply pad 220.

Referring to FIG. 9, the data connection pad part 250 has a data connection pad 258 connected to the data line DL, a gate shift clock input pad 254, an output enable signal input pad 255, a clock signal input pad 256, an inverted clock signal input pad 257, a gate on voltage input pad 252, a gate off voltage input pad 251, a common voltage input pad 253 and a gate start pulse input pad 185. Here, the data connection pad 258, the gate shift clock input pad 254, the output enable signal input pad 255, the clock signal input pad 256, the inverted clock signal input pad 257, the gate on voltage input pad 252 and the gate off voltage input pad 251 of FIG. 9 are same as the first exemplary embodiment of the LCD device, and thus any further repetitive explanations will be omitted. In the second exemplary embodiment, the common voltage VCOM is applied to the common voltage input pad 253.

The gate start pulse input pad 185 is connected to the gate start pulse supply line 170. The gate start pulse input pad 185 supplies the gate start pulse STV supplied from the timing controller 41 through the fifth signal line group 53 formed on the data driver 50 to the gate start pulse supply line 170. Therefore, the gate start pulse STV supplied from the timing controller 41 is applied to the first gate driver 60 through the data driver 50, the gate start pulse input pad 185, the gate start pulse supply line 170 and the gate start pulse supply pad 220.

Therefore, the second exemplary embodiment of the LCD device firstly drives the first gate driver 60 before the second gate driver 70 is driven, so that the image is normally displayed on the LCD panel although the position of the data driver is changed.

Hereinafter, a manufacturing method of the first exemplary embodiment of the LCD device will be explained with reference to FIGS. 2 to 6.

Referring to FIGS. 2 to 6, the manufacturing method of the first exemplary embodiment of the LCD device has a step of preparing an LCD panel having gate lines and data lines crossing each other and interpose an insulating layer, a step of coupling a first gate driver 60 for driving a switching element connected to a first gate line GL1 with a second gate driver 70 for driving a switching element connected to a last gate line GLn to a side of the LCD panel 100, a step of connecting a data driver 50 for driving the data lines to another side of the LCD panel 100, and a step of forming a gate start pulse supply line for supplying a gate start pulse generated from a timing controller 41 to the first gate driver 60.

Particularly, the step of preparing the LCD panel 100 includes preparing a TFT substrate 102 on which a TFT array is formed and a color filter substrate 101 on which a color filter array is formed. Then, the two substrates 101 and 102 are combined with each other through combining material.

Referring again to FIG. 2, the TFT substrate 102 is formed by forming the gate lines GL1, . . . GLn and the data lines DL1, . . . DLm crossing each other and interposing a gate insulating layer on an insulating substrate, and forming thin film transistors TFT coupled with the gate lines GL1, . . . GLn and the data lines DL1, . . . DLm. Referring again to FIG. 3A, a gate connection pad part 200 for connecting the first gate driver 60 is formed on a side of the TFT substrate 102. Here, a gate connection pad part for connecting the second gate driver 70 is also formed on the TFT substrate 102.

As shown in FIG. 3A, the gate connection pad part 200 having a gate pad 230 connected to the gate lines GL1, GL2, . . . , a gate start pulse input pad 220 applied to the gate start pulse and a common voltage supply pad 210 is formed. Here, the pads of the gate connection pad part 200 are formed by stacking a first conductive layer from which the gate lines are formed and an exposed conductive layer such as a transparent and conductive layer.

Here, a connection line 150 for connecting the gate start pulse input pad 220 to the common voltage supply pad 210 is formed. The connection line 150 may be formed from one of the first conductive layer from which the gate lines are formed, a second conductive layer from which the data lines are formed and the transparent and conductive layer. The connection line 150 is same as in FIGS. 3A to 5A, and thus any further repetitive explanation will be omitted.

Also, a data connection pad part 250 for connecting the data driver is formed on a lower portion of the TFT substrate 102. Referring again to FIG. 6, gate control signal pads 254 to 257 for receiving gate control signals and gate power supply pads 251 and 251 for receiving gate power signals are formed on one data connection pad part 50 of the data connection pad parts 250, which is adjacent to the second gate driver 70. Also, a data connection pad 258 connected to the data lines are formed. Here, the data connection pad part 250 is formed from at least one of the first conductive layer, the second conductive layer and the transparent and conductive layer.

When the gate lines GL1 to GLn or the data lines DL1 to DLm are formed on the TFT substrate 102, a first signal line group 110 and a second signal line group 120 of FIG. 2 are formed.

The first signal line group 110 is formed to connect between the data driver 50 and the second gate driver 70. Also, the second signal line group 120 is formed between the first and second gate drivers 60 and 70.

The color filter substrate 101 having a color filter in each of pixel regions and a common electrode receiving a common voltage is formed.

Particularly, red, green and blue color filters corresponding to the pixel regions are formed on a rear surface of the insulating substrate. The color filters may be formed by printing color resin on a substrate, or formed through a photo process.

The common electrode having a transparent and conductive material such as indium tin oxide (ITO), indium zinc oxide (IZO), etc., is formed on and entire surface.

Here, a black matrix for preventing light leakage may be formed using metal or opaque resin, before the color filters are formed.

Also, an overcoat may also be formed between the color filters and the common electrode to compensate a step between the color filters.

After a liquid crystal is injected between the TFT substrate and the color filter substrate, the two substrates are combined using combining material to form the LCD panel.

The first and second gate drivers 60 and 70 are coupled with the LCD panel 100. Here, the first and second gate drivers 60 and 70 are respectively aligned with the gate connection pad part 200 of the LCD panel. Particularly, the second gate driver 70 is aligned so that the fourth signal line group 75 is interposed between the first signal line group 110 and the second signal line group 120 that are formed on the LCD panel 100. Also, the first gate driver 60 is aligned so that the third signal line group 65 of the first gate driver 60 is electrically connected to the second signal line group 120.

Then, the data driver 50 is attached to the side adjacent to a region to which the second gate driver 70 of the LCD panel 100 is attached. Before the data driver 50 is attached, a side of the data driver 50 is attached to a printed circuit board 40 on which the timing controller 41 and a power supply 42 are mounted. Here, the data driver 50 is aligned on a data connection pad part 250 of the LCD panel 100 and is attached to the data connection pad part 250.

Here, the first and second gate drivers 60 and 70 and the data driver 50 are coupled to the LCD panel through a conductive adhesive such as an anisotropic conductive film (ACF) or soldering.

A manufacturing method of the second exemplary embodiment of the LCD device will be explained with reference to FIGS. 7 to 9.

Referring to FIG. 7, a gate start pulse supply line 170 is formed on an LCD panel 100. That is, the gate start pulse supply line 170 has same conductive material (e.g., a metal) and is formed on a same plane as data lines DL1, . . . DLm of the TFT substrate 102.

Particularly, after a gate pattern having gate lines GL1, . . . GLn is formed on an insulating substrate from a first conductive layer, a gate insulating layer is formed. Here, first and second signal line groups 110 and 120 may have same conductive material (e.g., a metal) and be formed on a same plane as the gate lines.

Then, a data line pattern having the data lines DL1, . . . DLm and the gate start pulse supply line 170 are formed from a second conductive layer.

Particularly, the second conductive layer is formed on the gate insulating layer through sputtering. Then, photoresist is formed on the second conductive layer, and is exposed through a mask having the data line pattern. The exposed photoresist is developed, and the second conductive layer is etched to form the data lines DL1, . . . DLm and the gate start pulse supply line 170.

Here, when the gate start pulse supply line 170 is independently formed on the LCD panel 100, a common voltage supply line 140 of the first to fourth signal line groups 110, 120, 65 and 75 is electrically connected to a short contact point 180 to supply a common voltage supplied from a power supply to short contact point 180.

In another exemplary embodiment, the gate start pulse supply line 170 may be formed from a transparent and conductive layer. That is, the gate start pulse supply line 170 may be formed from a same layer as the pixel electrode of the TFT substrate 102, and may have same material as the pixel electrode.

The step of forming the gate connection pad 200 and the data connection pad 250, and the step of connecting the first and second gate drivers 60 and 70 and the data driver 50 to the LCD panel 100 shown in FIGS. 8 and 9 are same as in the manufacturing method of the first exemplary embodiment of the LCD device. Thus, any further repetitive explanation will be omitted.

As in the illustrated embodiments, the gate start pulse supply line 170 for supplying the gate start pulse is formed on the first gate driver 60 connected to the first gate line of the LCD panel, so that the LCD panel is normally driven although the position of the data driver is changed.

As in the illustrated exemplary embodiments of the present LCD device, although a data driver 50 is formed on a lower portion of an LCD panel 100 of an LCD device, a common voltage supply line may be used as a gate start pulse supply line for supplying a gate start pulse to a first gate driver 60 that drives a first gate line.

Also, a gate start pulse supply line may be formed, and the gate start pulse may be supplied through the gate start pulse supply line.

Therefore, an image is normally displayed on the LCD panel, although the location of a data driver is changed.

Although the exemplary embodiments have been described, it is understood that the present disclosure should not be limited to these exemplary embodiments but various changes and modifications can be made by one ordinary skilled in the art within the spirit and scope of the present disclosure as hereinafter claimed.

What is claimed is:

1. A liquid crystal display (LCD) device, comprising:
an LCD panel displaying an image;
a first gate driver coupled to a side of the LCD panel to drive a switching element connected to a first gate line;
a second gate driver driving a switching element coupled to a last gate line;
a data driver coupled to another side of the LCD panel adjacent to the second gate driver to drive a data line;
a timing controller generating a gate start pulse applied to the first gate driver; and
a gate start pulse supply line supplying the gate start pulse to the first gate driver.

2. The LCD device of claim 1, further comprising a power supply generating a gate on/off voltage applied to the first and second gate drivers, and a common voltage applied to the LCD panel.

3. The LCD device of claim 2, wherein the gate start pulse supply line comprises a common voltage supply line of first to fourth signal line groups and a connection line formed on the LCD panel.

4. The LCD device of claim 3, wherein the first signal line group is formed on the LCD panel between the data driver and the second gate driver, and
the second signal line group is formed on the LCD panel between the first and second gate drivers.

5. The LCD device of claim 4, wherein the third signal line group is formed on the first gate driver to be connected to the second signal line group, and
the fourth signal line group is formed on the second gate driver to be connected between the first and second signal line groups.

6. The LCD device of claim 5, wherein the first gate driver comprises:
a common voltage supply part connected to the common voltage supply line of the third signal line group; and
a gate start pulse input part applying the gate start pulse.

7. The LCD device of claim 6, wherein the connection line connects the common voltage input part to the gate start pulse input part.

8. The LCD device of claim 7, wherein the connection line is formed of a same conductive material and on a same plane as one of the first gate line and the data line.

9. The LCD device of claim 2, wherein the gate start pulse supply line comprises a single line formed on the LCD panel.

10. The LCD device of claim 9, wherein the gate start pulse supply line is formed of a same conductive material and on a same plane as the data line.

11. The LCD device of claim 10, wherein the LCD panel further comprises:
a first signal line group formed on the LCD panel to supply signals generated from the timing controller and the power supply to the second gate driver; and
a second signal line group formed on the LCD panel between the first and second gate drivers.

12. The LCD device of claim 11, wherein the first gate driver comprises a third signal line group connected to the second signal line group,
the second gate driver comprises a fourth signal line group connecting the first signal line group to the second signal line group, and
the common voltage supplied from the power supply is applied to the LCD panel through the common voltage line of the first to fourth signal line groups.

13. The LCD device of claim 1, further comprising at least one gate driver formed between the first and second gate drivers to drive remaining gate lines except the gate lines connected to the first and second gate drivers.

14. A driving method of an LCD device, comprising:
supplying gate control signals generated from a timing controller to a plurality of gate drivers;
supplying a gate on/off voltage generated from a power supply to the gate drivers;
supplying a gate start pulse generated from the timing controller to a first gate driver of the gate drivers, the first gate driver driving a first gate line of an LCD panel; and
sequentially driving the gate drivers from the first gate driver so that the LCD panel normally displays an image although position of the gate drivers and a data driver are changed.

15. The driving method of claim 14, wherein the gate start pulse is applied to the first gate driver by supplying the gate start pulse through a common voltage supply line formed on the LCD panel and a common voltage supply line formed on the gate drivers.

16. The driving method of claim 15, wherein after the supplying the gate start pulse to the first gate driver,
further comprising sequentially driving gate lines connected to the first gate driver, and then sequentially driving gate lines connected to a next gate driver.

17. The driving method of claim 15, wherein the gate start pulse is supplied through a gate start pulse supply line independently formed on the LCD panel.

18. A manufacturing method of an LCD device, comprising:
preparing an LCD panel having gate lines and data lines crossing each other, the gate lines and the data lines interposing an insulating layer;
coupling a first gate driver for driving a switching element connected to a first gate line and a second gate driver for driving a switching element connected to a last gate line on a side of the LCD panel;
coupling a data driver for driving the data line to another side of the LCD panel adjacent to the second gate driver; and
forming a gate start pulse supply line supplying a gate start pulse generated from a timing controller to the first gate driver.

19. The manufacturing method of claim 18, wherein the LCD panel is prepared by:
forming a first signal line group connecting the data driver to the second gate driver; and
forming a second signal line group connecting the first and second gate drivers.

20. The manufacturing method of claim 19, wherein before the coupling the first and second gate drivers with the side of the LCD panel, further comprising:
forming a third signal line group in the first gate driver to be connected to the second signal line group; and
forming a fourth signal line group in the second gate driver to be connected between the first and second signal line groups.

21. The manufacturing method of claim 20, wherein the LCD panel is prepared by:
forming a common voltage input part coupled with the first gate driver; and
forming a gate start pulse input part receiving the gate start pulse from the first gate driver.

22. The manufacturing method of claim 21, wherein the LCD panel is prepared by forming a connection line connecting the gate start pulse input part to the common voltage input part.

23. The manufacturing method of claim 22, wherein the connection line is formed on a same plane and has a same material as one of the gate line and the data line.

24. The manufacturing method of claim 18, wherein the gate start pulse supply line is formed by forming a single line on the LCD panel.

25. The manufacturing method of claim 24, wherein the gate start pulse supply line is formed on a same plane and has a same conductor as the data line.
